(19) United States
(12) Patent Application Publication
(10) Pub. No.: US 2017/0302619 A1
(43) Pub. Date: Oct. 19, 2017

(54) System and Method for Automating Protocol Implementation in a Diameter Wireless Network

(71) Applicant: Virtual Network Element, Inc., Beverly, MA (US)

(72) Inventor: Kalidas Porika, Nashua, NH (US)

(73) Assignee: Virtual Network Element, Inc., Beverly, MA (US)

(21) Appl. No.: 15/133,213

(22) Filed: Apr. 19, 2016

(51) Int. Cl. H04L 29/12; H04L 29/06; H04L 12/947

(52) U.S. Cl. CPC H04L 61/203; H04L 49/25; H04L 69/22

(57) ABSTRACT

The present invention relates to computer implemented processes affected through a set of computer operations stored in a memory device and executed using a hardware processor. The embodiments disclosed herein comprise methods as well a computer hardware system comprising a hardware processor capable of executing the method steps. The computer operations facilitate processes for (1) automating the creation of encoders or decoders integral to a protocol wrapper within a wireless network configured to transmit and receive Diameter based protocol data; and (2) transmitting agnostic Diameter based protocol data in a wireless network.

### FIELD

The present invention relates generally to a system and method for an automated protocol implementation generator in wireless communication networks, specifically those operating over a Diameter protocol.

### BACKGROUND

In legacy networks, such AMPS and 2G, voice calls were provided over a switched, circuit-style network. As mobile phone usage became more ubiquitous, network developers and standards bodies responded by adopting the IP Multimedia Subsystem, also known as the IP Multimedia Core Network Subsystem (“IMS”), as the architectural framework for delivering IP multimedia services, which include data, voice, and video.

The signaling protocol for IMS in the 3G network, as well as in the Evolved Packet Core (“EPC”) networks for 4G LTE, is the DIAMETER protocol, which was adopted by the Internet Engineering Task Force as document number RFC 6733, the entire contents of which are hereby incorporated by reference. The Diameter base protocol, like its predecessor, the RADIUS protocol, is intended to provide an authentication, authorization, and accounting framework (“AAA”) for applications such as network access or IP mobility in both local and roaming situations.

In modern 3G, 4G, or 5G networks, there are myriad network elements that provide services, such as voice, data, and video, to network subscribers. These network elements work with each other over defined protocols. At any given time, a network can be running on a base protocol, for example the DIAMETER Base Protocol, while simultaneously using protocol extensions, which integrate with the Diameter Base protocol, to govern communication between each of the myriad network elements.

The Diameter base protocol is an authentication, authorization, and accounting protocol. The purpose of an authentication, authorization, and accounting framework is to provide access control as well as secure data transmission. In current wireless networks that require authentication, authorization, and accounting functionality, the Diameter protocol allows network designers to define their own own extensions, which can run on top of the Diameter base protocol. In practice, hundreds of these extensions have been developed and adopted as standards. By way of example, the ETSI TS 129 family of standards, which operates in Universal Mobile Telecommunications (“UMTS”) or Long Term Evolution (“LTE”) networks, sometimes referred to as the 3GPP TS 29.xxx family of standards, includes 3GPP TS 29.214 version 12.9.0 Release 12, entitled “Policy and charging control over Rx reference point,” (“Rx extension”), the entire contents of which are hereby incorporated by reference. An alternate example of a network extension is 3GPP TS 29.212 version 7.4.0 Release 7 entitled “Policy and charging control over Gx reference point,” (“Gx extension”), the entire contents of which are hereby incorporated by reference. For a complete list of all of the 3GPP TS 29.xxx standards, see http://www.3gpp.org/DynaReport/29-series.htm, the entire contents of all of the standards listed therein are hereby incorporated by reference.

Every element within an IMS network is communicatively coupled to an encoder and a decoder, which is used, respectively, to encode messages before they are transmitted or decode messages upon receipt. Encoding and decoding is part of the security protections offered by the Diameter based protocols. One of the challenges of this model is—network elements within the IMS network use different Diameter protocol extensions to communicate with one another. If for example, a data exchange was transpiring between an Application Function network element and a Policy and Charging Rules Function element, that exchange would be occurring over an Rx Diameter protocol extension. If, on the other hand, the data exchange was occurring between the Policy and Charging Rules Function element and a Policy and Charging Enforcement Function element, that exchange would transpire using a Gx Diameter protocol extension. This variability has at least two drawbacks: (1) the complexity of programming encoders and decoders for each of the individual network elements, and there are hundreds, must be done manually and individually, which is costly; and (2) data speed is minimized because messages being routed to any element that is further than a one-hop neighbor must be encoded and decoded multiple times depending upon the Diameter protocol extensions existing along the pathway traversed by the data. Accordingly, it would be advantageous to: (1) find a way to automate creation of the software coding that must be included with each of the encoders and decoders; or (2) perform encoding and decoding in a more universal fashion irrespective of which network element is transmitting or receiving the data.

### SUMMARY OF THE INVENTION

The present invention relates to computer implemented processes affected through a set of computer operations stored in a memory device and executed using a hardware processor. The embodiments disclosed herein comprise methods as well a computer hardware system comprising a hardware processor capable of executing the method steps. The computer operations facilitate processes for (1) automating the creation of encoders or decoders integral to a protocol wrapper within a wireless network configured to transmit and receive Diameter based protocol data; and (2) transmitting agnostic Diameter based protocol data in a wireless network.

In alternate embodiments, the present invention discloses a computer hardware system comprising a hardware processor including a code generator wherein the hardware processor is configured to initiate or perform: (1) automating the creation of encoders or decoders integral to a protocol wrapper within a wireless network configured to transmit and receive Diameter based protocol data; and (2) transmitting agnostic Diameter based protocol data in a wireless network.

### BRIEF DESCRIPTION OF THE DRAWINGS

FIG. 1 is a block diagram showing a portion of the network layers and the communicative couplings between the layers in a wireless network.

FIG. 2 is a block diagram showing connections between exemplary wireless network elements in a network configured to transmit and receive Diameter protocol messages.

FIG. 3 is a block diagram showing the structure of a Diameter protocol data packet.

FIG. 4 is a block diagram showing the relationship between the Diameter interface, commands, AVPs, and optionally group AVPs.

FIG. 5 is a block diagram showing steps of a method according to the embodiments of the present invention.

FIG. 6 is a block diagram showing steps of a method according to the embodiments of the present invention.

FIG. 7 is a block diagram of an instance of a computer system suitable for implementing embodiments of the present disclosure

### DETAILED DESCRIPTION

In an OSI network, the presentation layer establishes context between application-layer entities, in which the application-layer entities may use different syntax and semantics if the presentation service provides a bit mapping between them. If a mapping is available, presentation service data units are encapsulated into session protocol data units, and passed down the protocol stack. This layer provides independence from data representation (e.g., encryption) by translating between application and network formats. The presentation layer transforms data into a form that the application accepts. This layer formats and encrypts data to be sent across a network

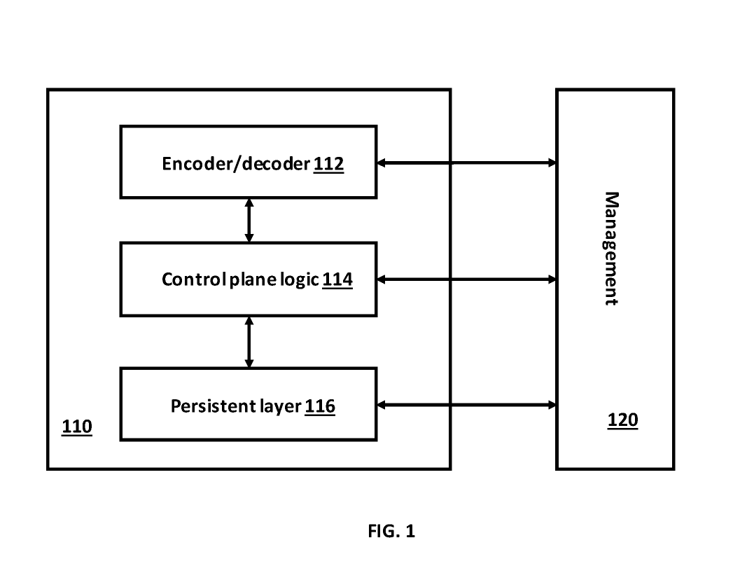

FIG. 1 shows a portion of the presentation layer, namely the control plane 110 and the management plane 120 of a wireless network element. As can be seen in FIG. 1, the control plane 110 is further comprised of an encoder/decoder 112, control plane logic 114, and a persistent layer 116. The encoder/decoder 112, also sometimes called a protocol wrapper, is the top level of the control plane. The main function of the encoder/decoder 112 is to translate incoming and outgoing messages into a format that can be understood by the application layer, which although is not pictured, is communicatively coupled to the control plane 110 in an OSI wireless network. One of the reasons that wireless networks must have an encoder/decoder 112 is because there are myriad protocols used to transmit data. As such, the data structure will vary depending on the protocol used.

The control plane logic 114 processes commands, makes logical decisions and evaluations, and performs calculations. It also moves and processes data between the encoder/decoder 112 and the persistent layer 116. The persistent layer 116 is comprised of memory and processors used to store and retrieve information. NoSQL, Graphic Database, in-memory database or similar memory devices known to those of skill in the art can be used in the persistent layer 116.

This invention relates generally to a code generator used to implement encoding and decoding functionality within the control plane 110. Understanding how the protocol implementation would take place in the prior art, and what this invention contributes to the art, requires a brief discussion of the Diameter message format. A Diameter message is the base unit to send a command or deliver a notification to other Diameter nodes. For different purposes, the Diameter protocol has defined several types of Diameter messages, which are identified by their command code. For example, an Accounting-Request message recognizes that the message carries accounting-related information, while a Capability-Exchange-Request message recognizes that the message carries capability information of the Diameter node sending the message. Because the message exchange style of Diameter is synchronous, each message has its corresponding counterpart, which shares the same command code. In both previous examples, the receiver of a request message prepares and sends a corollary answer message and sends it to the original sender, e.g., an Accounting-Answer or a Capability-Exchange Answer.

The command code is used to identify the intention of a message, but the actual data is carried by a set of Attribute-Value-Pairs (AVPs). These AVPs carry the details of Accounting AA as well as routing, security, and capability information between two Diameter nodes. The Diameter protocol has predefined a set of common attributes wherein each attribute has a corresponding semantic. In addition, each AVP is associated with an AVP Data Format, which is defined within the Diameter protocol (for example, OctetString, Integer32), so the value of each attribute must follow the data format.

One example, which will be used as an exemplary embodiment, is a portion of a wireless network that would operate using an Rx extension protocol. The Figures below related to the portion of the network that would communicate via an Rx extension protocol. These figures, however, and the steps/functions of the description related to the Rx embodiment are used as a general example of how the code generator would work. The principles discussed throughout this application are generally applicable to all known or future created Diameter base protocols and Diameter base protocol extensions.

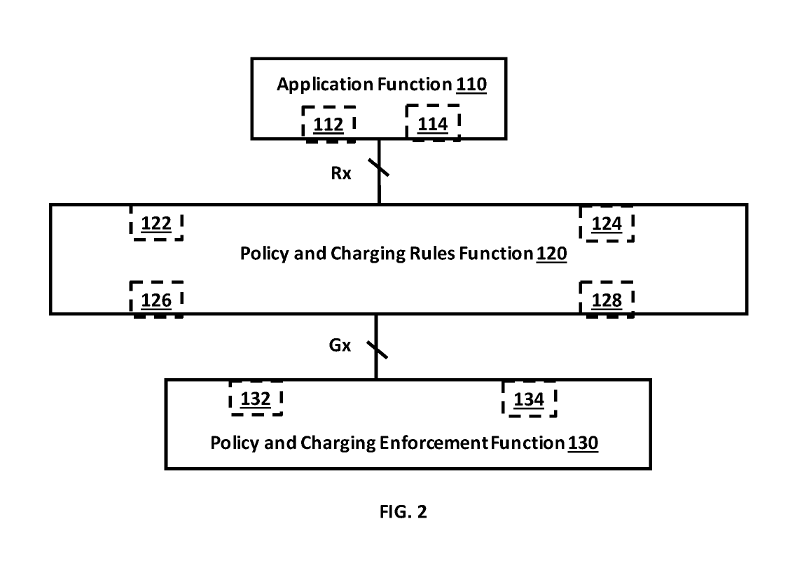

FIG. 2 shows a portion of an IMS network including an Application Function (“AF”) element 210, a Policy and Charging Rules Function (“PCRF”) element 220, and a Policy and Charging Enforcement Function (“PCEF”) element 230. The AF 210, PCRF 220, and PCEF 230 elements each have an encoder and a decoder communicatively coupled thereto. The AF element 210 has an AF encoder 212 and AF decoder 214 therein. Similarly, the PCRF has PCRF encoders 222 and 226 and PCRF decoders 224 and 228. And the PCEF has PCEF encoder 232 and PCEF decoder 234.

In current implementations, the network is designed so that the AF element 210 communicates with the PCRF element 220 using an Rx extension protocol. Similarly, the PCRF element 220 communicates with the PCEF element 230 using a Gx extension protocol. Accordingly, AF encoder 212 and PCRF encoder 222 will be programmed by network engineers prior to deployment to be able to encode Diameter base protocol messages as well as Rx extension protocol messages. AF decoder 214 and PCRF decoder 224 will be programmed to decode Diameter base protocol messages and Rx extension protocol messages. PCRF encoder 226 and PCEF encoder 232 will be programmed to encode Diameter base protocol messages and Gx extension protocol messages. PCRF decoder 228 and PCEF decoder 232 will be programmed to decode Diameter base protocol messages and Gx extension protocol messages.

Rather than having the encoder and decoder programming performed by network engineers prior to element deployment, embodiments of the current invention automate the process of encoding and decoding data transmitted using the Diameter protocol and its various protocol extensions. Moreover, additional embodiments of the present invention allow for transmissions between network elements, such as the AF 210, PCRF 220, PCEF 230, and so forth using non-standard protocol messaging by placing a translating element within the network. For example, in some embodiments of the present invention, it is possible to establish a direct communication link between, for example, the AF 210 and the PCEF 230, wherein messages could be translated via an intermediary connection with a Diameter routing agent embodiment discussed in ore detail below.

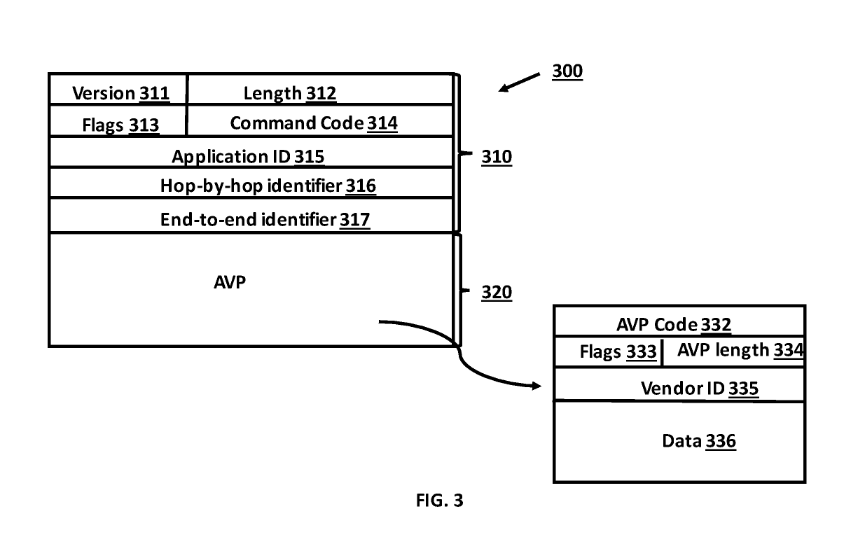

FIG. 3 shows the Diameter packet 300 format for data messages being exchanged according to the Diameter base and Diameter extension protocols. As can be seen in FIG. 3, the Diameter packet 300 is comprised of a header 310 and a payload 320. The header 310 includes information regarding, among other things, a command code 314 and an application ID 315. Every Diameter message must contain a command code in its header's command code 314 field, which is used to determine the action to be taken for a particular message. See generally Ch. 3, Diameter base protocol. The application ID 315 signifies which protocol extension, if any, is being used to for data transmission.

The Diameter protocol has many application IDs 315 and many command codes 314 that correspond to these application IDs 315. There are thousands of combinations that can be created between application IDs 315 and command codes 314. The combination of application IDs 315 and command codes 314 is used to create an interface between elements. Moreover, the application ID 315 and the command code 314, when taken together, uniquely identify a command contained within the header 310.

The payload 320 is comprised of an attribute value pair or AVP. Diameter AVPs 320 carry specific authentication, accounting, authorization, and routing information as well as configuration details for the request and reply. See generally Chapter 4, Diameter base protocol. A breakdown of the AVP format 330 is shown in FIG. 3. As can be seen, the AVP 320 includes an AVP code 332, flags 333, an AVP length 334, a vendor identification 335, and data 336.

The information that must be contained within the AVP 320 depends directly upon the command code 314. The Diameter base protocol and the Diameter extension protocols delineate certain rules regarding whether a particular data filed must be included, may be included, or must not be included within an AVP 320 for each of the possible command codes 314 that could appear in the header 310. Specifically, “[e]very command code MUST include a corresponding command code format specification which is used to define the AVPs that MUST or MAY be present when sending this message.” See Ch. 3.2 Diameter base protocol.

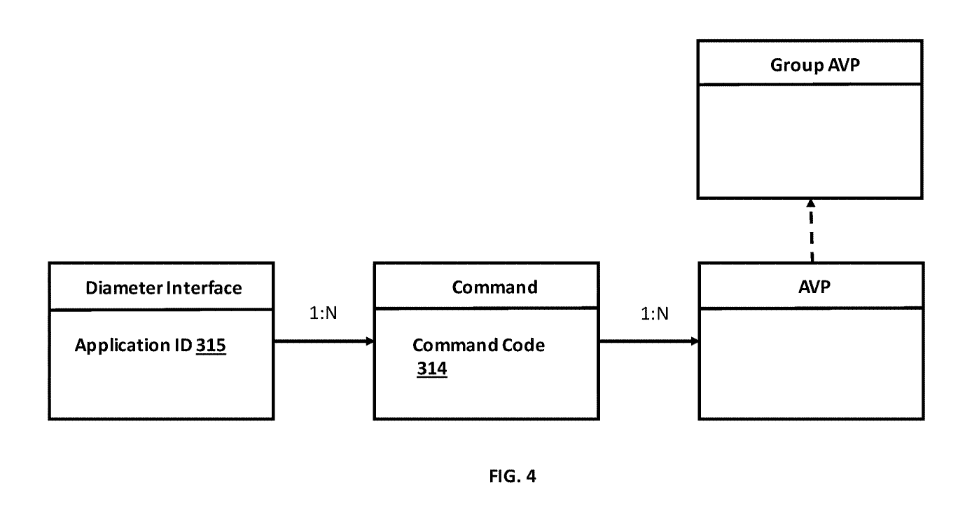

FIG. 4 shows the relationship between the Diameter interface, commands, AVPs, and optionally group AVPs. Each Diameter interface has a unique application ID, which is an unsigned 32-bit integer. By way of example, the application ID for the Diameter base protocol is 0. The application ID for the RX protocol extension is 16777236. The application ID for the Gx protocol extension is 16777238. Referring back to FIG. 3, the application ID 315 portion of the header, which is a 32-bit unsigned integer, indicates which protocol interface applies to the data packet 300.

Turning back to FIG. 4, for each Diameter interface there are numerous commands, also called verbs, associated with that interface. For example, in the Diameter base protocol, there are fourteen commands. Each command is uniquely identified by its command code 314. Table 1 shows the command name, its abbreviation, and the command code for the fourteen Diameter base protocol messages.

| Command Name | Abbreviation | Command Code |
|---|---|---|
| Abort-Session-Request | ASR | 274 |
| Abort-Session-Answer | ASA | 274 |
| Accounting-Request | ACR | 271 |
| Accounting-Answer | ACA | 271 |
| Capabilities-Exchange- | CER | 257 |
| Request | | |
| Capabilities-Exchange- | CEA | 257 |
| Answer | | |
| Device-Watchdog-Request | DWR | 280 |
| Device-Watchdog-Answer | DWA | 280 |
| Disconnect-Peer-Request | DPR | 282 |
| Disconnect-Peer-Answer | DPR | 282 |
| Re-Auth-Request | RAR | 258 |
| Re-Auth-Answer | RAA | 258 |
| Session-Termination- | STR | 275 |
| Request | | |
| Session-Termination- | STA | 275 |
| Answer | | |

As can be seen in FIG. 3, the Command Code 314 is part of the header 310 of a Diameter data packet 300. The command code 314 is a 24-bit unsigned integer. As can be seen in Table 1, under the Diameter protocol, every request has a corresponding answer. This parity lends itself to a Boolean representation wherein the answer/request pairs can be entered into a database as a

Referring again to FIG. 4, just as there was a 1-N relationship between the Diameter interface and command codes, there is also a 1-N relationship between command codes and AVP codes. This means that there are many AVPs that correspond to each command code. In the standards governing the Diameter base protocol and its protocol extensions, there are rules regarding what MUST be, what MAY be, and what CANNOT be in an AVP. These rules of what should and should not be included in the AVP are unique for each command code.

For example, in the Reauthorization-Answer command for the Rx protocol extension, which has a command code of 258, the command code format MUST include one instance of the following fields: (a) Session ID; (b) Origin Host; and (c) Origin Realm. When an encoder or decoder is sending or receiving an Rx Diameter extension protocol, a validation check will be performed on the data packet 300 to ensure that it contains one, and only one instance of a Session ID, Origin Host, and Origin Realm in the payload.

In addition, the RRA command has many additional optional fields that may be included within the message. For example, the RRA command message may also include the following fields: Result-Code, Experimental Result, Media Component Description, Service URN, Origin State ID, Class, Error Message, Error Reporting Host, Redirect Host, Redirect Host Usage, Redirect Max Cache Time, Failed AVP, and Proxy Info.

Referring to FIG. 4, the Diameter protocol allows for the concept of group affiliated AVPs, that is attributes that have a familial data relationship. This feature allows programmers to group data packets together as being related to one another in, for example, a parent-child relationship. Data packets within a family will share common AVP identifying information.

As can be seen from this one example of what the format of the AVP associated with a specific command code 314, in this case the RRA command, the details of what must be included are specific and somewhat lengthy. When one considers the hundreds or predefined command codes 314, as well as the option within Diameter to create custom command codes 314 and to group data packets into structured, familial relationships, it is easy to see how voluminous the various correlations between the command codes 314 and their unique command code format becomes as one is tasked with developing the code for encoders and decoders of Diameter wireless networks.

In embodiments of the present invention, we disclose a code generator that automates the process of manually coding all of the various command code/command code formats for what must, may, or must not be included within the AVP 320 for each command code 314. The code generator is communicatively coupled to a relational database, which itself is comprised of a processor and memory. In embodiments herein, the database could have stored therein a plurality of application IDs 315 and command codes 314 as well as the unique command code format corresponding to each of these combinations.

In an alternate embodiment, the code generator could automatically create encoders and decoders that are able to process Diameter messages in an agnostic fashion. Embodiments of these code generators would be stored in computer system having a hardware processor and a memory device. The computer system would be communicatively coupled to a wireless network wherein data are transmitted and received, at least some of the time, using a Diameter based protocol or any of the extensions to the Diameter based protocol that have been heretofore developed. Those of skill in the art will recognize that the Diameter based protocols are flexible enough to allow for custom protocol extensions to be built by practitioners in the art. Equally important, those of skill in the art will recognize that the Diameter based protocols in use today may change over time in that they standards may be updated or evolve so as to accommodate future requirements for data transmission and reception. Just as the Radius protocol was updated to accommodate greater demands on wireless networks, so too may the Diameter protocol be updated to accommodate future demands placed on wireless networks. In that instance, those of skill in the art will recognize the applicability of the concepts discussed in embodiments disclosed herein to customized Diameter based protocols as well as future changes to the protocol and the standards adopted by various standards bodies who oversee all of the Diameter based protocols.

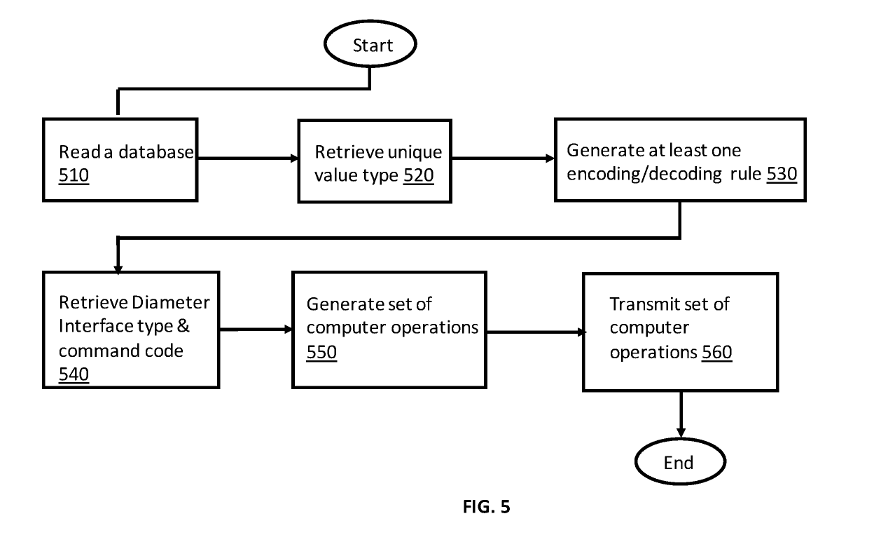

FIG. 5 shows the steps of one embodiment of a computer implemented method for automating the creation of an encoder or a decoder integral to an agnostic protocol wrapper in a wireless network. This computer implemented method could be used by systems engineers tasked with programming the individual encoders and decoders that are a part of today's wireless networks. As previously stated, these encoders and decoders are currently programmed on an individual basis by systems engineers. Additionally, each encoder and decoder is correlated to a specific network element and the Diameter protocol associated with that network element. For example, the encoder and decoder built for the AF 210 and the PCRF 220 would be designed to transmit and receive messages in a Diameter base protocol format or an Rx extension protocol.

Embodiments herein offer at least two advantages over the prior art. First, encoders and decoders can be programmed automatically. Second, the programming of the encoders and decoders is done is such a way as to facilitate data transmission in an agnostic fashion within the Diameter framework. This has been achieved by noting the patterns and commonalities present in all Diameter protocols. The embodiments disclosed herein are adapted to not recognize patterns within the current Diameter protocols but to allow for the creation of custom Diameter protocols.

Turning to FIG. 5, the first step in the automated process for creating encoders and decoders is reading 510, using a hardware processor configured to read and analyze data stored in a memory device, a database having a data structure stored therein. In embodiments, this data structure is as was discussed above, the data structure for Diameter based protocols and their respective extensions including custom made extensions. Next, the computer implemented process retrieves 520, using the hardware processor, a unique value type associated with an attribute value pair from the database. Then the computer implemented process generates 530, using the hardware processor, at least one encoding rule or at least one decoding rule based on the unique value type. Having generated 530 at least one encoding or decoding rule, the computer implemented process then retrieves 540, using the hardware processor, Diameter interface type and a command code from the database.

Next, the computer implemented process generates 550, using the hardware processor, a set of computer operations based on at least one encoding or decoding rule, the Diameter interface type, and the command code. After that, the computer implemented process transmits 560 the set of computer operations to a memory device communicatively coupled to a Diameter protocol wrapper.

In an alternate embodiment, the Diameter protocol wrapper could be an agnostic Diameter protocol wrapper. The agnostic Diameter protocol wrapper is configured to perform similarly to how a Diameter protocol wrapper would function in current wireless networks capable of transmitting and receiving Diameter messages. The main difference, however, with an agnostic Diameter protocol wrapper is, it is not uniquely tailored to only one Diameter protocol or Diameter protocol extension. Rather, it is Diameter protocol agnostic, and therefore is capable of receiving and sending any type of Diameter based data, even data generated using custom made Diameter protocols.

In terms of the physical location of the hardware configured to run the computer implemented process described above, it could be integral to one or more of the wireless network elements, for example, and without limitation, the AF 210, the PCRF 220, and the PCEF 230. Alternatively, the hardware could be communicatively coupled to network elements via a cellular, Wi-Fi, TV White Space, optical, or wired connection.

In an alternate embodiment, there is disclosed a computer implemented method for transmitting agnostic Diameter protocol data in a wireless network. As was the case with previous embodiments, the computer implemented methods of this embodiment could be performed using hardware such as a processor and a memory storage device. The computer hardware would be communicatively coupled to a wireless network element capable of transmitting and receiving data formatted in a Diameter based protocol, including custom made extensions of the Diameter based protocol.

In today's wireless networks configured to transmit and receive Diameter protocol data, one of the network elements is a Dynamic Routing Agent (“DRA”). The Diameter Routing Agent is a functional element in a 3G or 4G (such as LTE) network that provides real-time routing capabilities to ensure that messages are routed among the correct elements in a network. The DRA was introduced by the 3GPP to address the increased Diameter signaling traffic and growing complexity of 4G LTE networks.

Some of this complexity comes from the enhanced services that communications service providers (CSPs) introduced in 3G and 4G LTE networks, such as tiered charging, converged billing, and policy enforcement control. These services require other Diameter-based functionalities, including PCRFs, PCEFs, Home Subscriber Server (“HSS”), and more, to support complex user-service connections. A DRA controls and manages the Diameter signaling among these elements to ensure that the proper connections are made.

Networks with complex architectures and multiple Diameter nodes require an advanced Diameter contextual routing engine. Choosing a DRA that is capable of advanced contextual routing is essential to managing network complexity and capitalizing on all that 4G LTE has to offer.

The DRA ensures that all Diameter sessions established over the Gx, S9, Gxx, Rx and other reference points for a certain IP Connectivity Network Access (“IP-CAN”) session reach the same PCRF when multiple and separately addressable PCRFs have been deployed in a Diameter realm.

The DRA maintains PCRF routing information per IP-CAN session or per User Equipment Network Access Identifier (“UE-NAI”), depending on the operator's configuration. In some instances, the DRA selects the same PCRF for all the Diameter sessions established for the same UE. In other instances, the DRA selects the same PCRF per S9 session for the same UE. The DRA has information about the user identity (UE NAI), the UE IPv4 address and/or IPv6 prefix, the Access Point Name (“APN”), if available, and the selected PCRF address for a certain IP-CAN session.

The PCRF routing information stored for an IP-CAN session in the DRA is removed after the IP-CAN session is terminated. In case of a DRA change (e.g. inter-operator handover), the information about the IP-CAN session stored in the old DRA is removed. The PCRF routing information stored per UE in the DRA may be removed when no more IP-CAN and gateway control sessions are active for the UE.

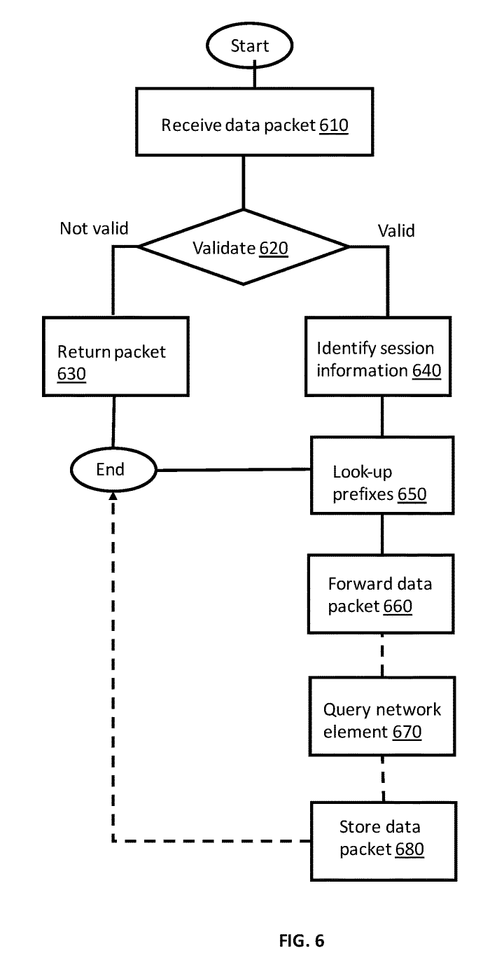

In embodiments of the present invention, an operator, such as Verizon, AT&T, T-Mobile and the like can add a new DRA interface, which communicates with other network elements within the wireless network at run-time. In this computer-implemented embodiment, the steps of which are shown in FIG. 6, a processor, running the computer implemented process and having stored thereon a set of operational code, receives 610 a data packet associated with a first Diameter protocol.

Next, a hardware processor executes computer operations stored within a memory that allow it to validate 620 the data packet according to the encoding or decoding rules of the network element at which the data packet is received 610. If the validation 620 fails, the embodiments herein return 630 the data packet back to the network element from which it was received 610 appending an appropriate error code. If it passes, embodiments herein identify 640 the session information for each subscriber. In some embodiments, session AVPs could be, without limitation, IPv6 prefix, IMSI/MSISDN of the subscriber, any of the attributes that uniquely identify the subscriber session, or similar session AVPs known to those of skill in the art.

Next, the computer-implemented embodiments look-up 650 pre-configured IPv6 prefixes, or any other prefixes attendant to the session AVP, with corresponding destination network elements. After having performed this step, embodiments herein forward 660 the data packet to the appropriate network element.

In an alternate embodiment, the new DRA interface may have to query 670 an additional network element, for example the HSS, to obtain routing information for a particular subscriber so that the data can be sent to the proper destination. In these embodiments, the query 670 could transpire over an Sh interface, which would allow the DRA interface to store 680 the data packet in memory until it receives routing information from the HSS or other network element, which was queried 670.

In alternate embodiments, the present invention discloses a computer hardware system comprising a hardware processor, including a code generator, capable of executing the steps of: (a) reading a database having a data structure stored therein; (b) retrieving a unique value type associated with an attribute value pair from the database; (c) generating at least one encoding rule or at least one decoding rule based on the unique value type; (d) retrieving a Diameter interface type and a command code from the database; (e) generating a set of computer operations based on the at least one encoding or decoding rule, the Diameter interface type and the command code; and (f) transmitting the set of computer operations to a memory device communicatively coupled to an agnostic protocol wrapper. In an alternate embodiment, the protocol wrapper is an agnostic protocol wrapper.

In an alternate embodiment, the present invention discloses a computer hardware system comprising a hardware processor capable of executing the steps of: (a) receiving a data packet associated with a first Diameter protocol at a Diameter routing agent; (b) analyzing the data packet to determine a destination and a first application identification of the data packet; (c) reading a memory storage device to determine a second application identification based on the destination of the data packet; and (d) converting the data packet to a second Diameter protocol if the second application identification is different than the first application identification.

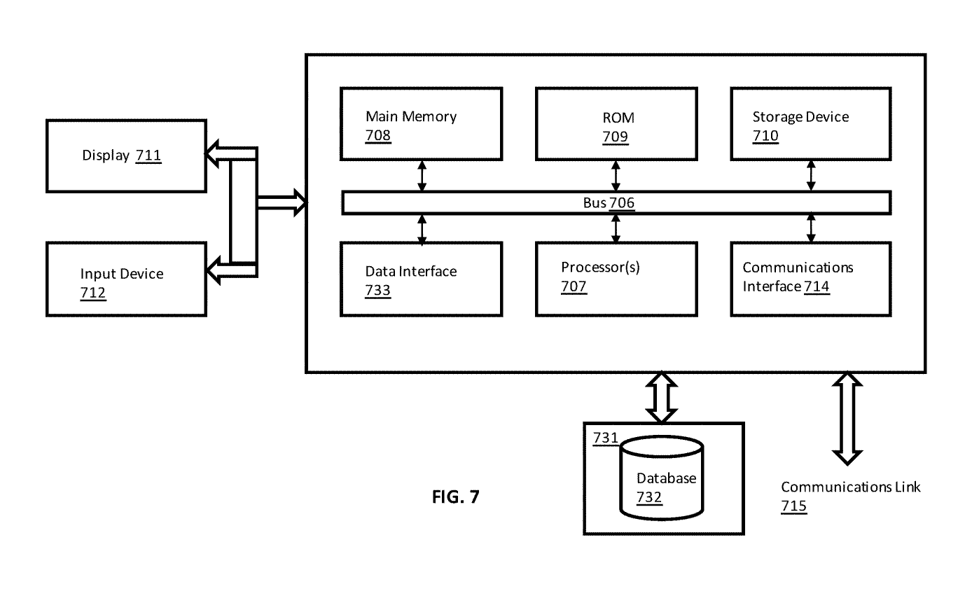

FIG. 7 depicts a block diagram of an instance of a computer system 700 suitable for implementing embodiments of the present disclosure. Computer system 700 includes a bus 706 or other communication mechanism for communicating information, which interconnects subsystems and devices, such as a processor 707, a system memory 708 (e.g., RAM), a static storage device (e.g., ROM 709), a disk drive 710 (e.g., magnetic or optical), a data interface 733, a communication interface 714 (e.g., modem or Ethernet card), a display 711 (e.g., CRT or LCD), input devices 712 (e.g., keyboard, cursor control), and an external data repository 731.

According to one embodiment of the disclosure, computer system 700 performs specific operations by processor 707 executing one or more sequences of one or more instructions contained in system memory 708. Such instructions may be read into system memory 708 from another computer readable/usable medium, such as a static storage device or a disk drive 710. In alternative embodiments, hardwired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to processor 707 for execution. Such a medium may take many forms, including but not limited to, non-volatile media and volatile media. Non-volatile media includes, for example, optical or magnetic disks, such as disk drive 710. Volatile media includes dynamic memory, such as system memory 708.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system 700. According to certain embodiments of the disclosure, two or more computer systems 700 coupled by a communications link 715 (e.g., LAN, PTSN, or wireless network) may perform the sequence of instructions required to practice the disclosure in coordination with one another.

Computer system 700 may transmit and receive messages, data, and instructions, including programs (e.g., application code), through communications link 715 and communication interface 714. Received program code may be executed by processor 707 as it is received, and/or stored in disk drive 710 or other non-volatile storage for later execution. Computer system 700 may communicate through a data interface 733 to a database 732 on an external data repository 731. A module as used herein can be implemented using any mix of any portions of the system memory 708, and any extent of hard-wired circuitry including hard-wired circuitry embodied as a processor 707.

Those of skill in the art will recognize throughout this specification that when like terms are used to describe features and functionalities of various portions of a particular embodiment, those same features and functionalities could be present in additional embodiments having aspects with like terms.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context.

The invention includes embodiments in which exactly one member of the group is present in, employed in, or otherwise relevant to a given product or process. The invention also includes embodiments in which more than one or the entire group of members is present in, employed in or otherwise relevant to a given product or process. Furthermore, it is to be understood that the invention encompasses all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise.

Where elements are presented as lists, (e.g., in Markush group or similar format) it is to be understood that each subgroup of the elements is also disclosed, and any element(s) can be removed from the group. It should be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in so many words herein. It should also be understood that any embodiment or aspect of the invention can be explicitly excluded from the claims, regardless of whether the specific exclusion is recited in the specification. The entire contents of all of the references (including literature references, issued patents and published patent applications and websites) cited throughout this application are hereby expressly incorporated by reference.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification, embodiments have been described in a way which enables a clear and concise specification to be written, but it is intended and will be appreciated, that embodiments may be variously combined or separated without departing from the invention. It is intended that the present invention be limited only to the extent required by the appended claims and the applicable rules of law.

What is claimed is:

1. A computer implemented method for automating the creation of an encoder or a decoder integral to a protocol wrapper in a wireless network using a processor executing a process to perform one or more steps, the steps comprising:
a. reading a database having a data structure stored therein;
b. retrieving a unique value type associated with an attribute value pair from the database;
c. generating at least one encoding rule or at least one decoding rule based on the unique value type;
d. retrieving a Diameter interface type and a command code from the database;
e. generating a set of computer operations based on the at least one encoding or decoding rule, the Diameter interface type and the command code; and
f. transmitting the set of computer operations to a memory device communicatively coupled to an agnostic protocol wrapper.

2. The computer implemented method of claim 1 wherein the protocol wrapper is an agnostic protocol wrapper.

3. A computer implemented method for transmitting protocol agnostic data in a wireless network using a Diameter protocol using a processor executing a process to perform one or more steps, the steps comprising:
a. receiving a data packet associated with a first Diameter protocol at a Diameter routing agent;
b. validating the data packet according an encoding or decoding rule of a network element at which it was received;
c. returning the data packet if the validation fails;
d. identifying a session information for a subscriber if the validation passes;
e. looking up a prefix; and
f. forwarding the data packet to a destination network element.

4. The computer implemented method of claim 3 further comprising the steps of:
a. querying a subscriber network element to obtain routing information; and
b. optionally storing the data packet until a routing destination is received.

5. A computer hardware system comprising a hardware processor including a code generator wherein the hardware processor is configured to initiate or perform:
a. reading a database having a data structure stored therein;
b. retrieving a unique value type associated with an attribute value pair from the database;
c. generating at least one encoding rule or at least one decoding rule based on the unique value type;
d. retrieving a Diameter interface type and a command code from the database;
e. generating a set of computer operations based on the at least one encoding or decoding rule, the Diameter interface type and the command code; and
f. transmitting the set of computer operations to a memory device communicatively coupled to an agnostic protocol wrapper.

6. The computer hardware system of claim 5 wherein the the protocol wrapper is an agnostic protocol wrapper.

7. A computer hardware system comprising a hardware processor including a code generator wherein the hardware processor is configured to initiate or perform:
a. receiving a data packet associated with a first Diameter protocol at a Diameter routing agent;
b. validating the data packet according an encoding or decoding rule of a network element at which it was received;
c. returning the data packet if the validation fails;
d. identifying a session information for a subscriber if the validation passes;
e. looking up a prefix; and
f. forwarding the data packet to a destination network element.

8. The computer hardware system of claim 7 comprising a hardware processor including a code generator wherein the hardware processor is further configured to initiate or perform:
a. querying a subscriber network element to obtain routing information; and
b. optionally storing the data packet until a routing destination is received.

9. A computer program product embodied in a non-transitory computer readable medium, the computer readable medium having stored thereon a sequence of instructions which, when executed by a processor causes the processor to execute a process, the process comprising:
a. reading a database having a data structure stored therein;
b. retrieving a unique value type associated with an attribute value pair from the database;
c. generating at least one encoding rule or at least one decoding rule based on the unique value type;
d. retrieving a Diameter interface type and a command code from the database;
e. generating a set of computer operations based on the at least one encoding or decoding rule, the Diameter interface type and the command code; and
f. transmitting the set of computer operations to a memory device communicatively coupled to an agnostic protocol wrapper.

10. The computer program product of claim 9 wherein the the protocol wrapper is an agnostic protocol wrapper.

11. A computer program product embodied in a non-transitory computer readable medium, the computer readable medium having stored thereon a sequence of instructions which, when executed by a processor causes the processor to execute a process, the process comprising:
a. receiving a data packet associated with a first Diameter protocol at a Diameter routing agent;
b. validating the data packet according an encoding or decoding rule of a network element at which it was received;
c. returning the data packet if the validation fails;
d. identifying a session information for a subscriber if the validation passes;
e. looking up a prefix; and
f. forwarding the data packet to a destination network element.

12. The computer program product of claim 11 wherein the sequence of instructions causes the processor to further execute steps comprising:
a. querying a subscriber network element to obtain routing information; and
b. optionally storing the data packet until a routing destination is received.
